(19) United States
(12) Patent Application Publication
(10) Pub. No.: US 2025/0296256 A1
(43) Pub. Date: Sep. 25, 2025

(54) PERSONAL CARE DEVICE

(71) Applicant: Braun GmbH, Kronberg (DE)

(72) Inventors: Cirilo Javier PEREZ LOPEZ, Frankfurt am Main (DE); Andreas ERNDT, Kelkheim (DE); Bernhard SIKORA, Kelkheim (DE); Wolfgang STEGMANN, Moerfelden Walldorf (DE)

(21) Appl. No.: 19/086,549

(22) Filed: Mar. 21, 2025

(30) Foreign Application Priority Data
Mar. 21, 2024 (EP) 24165195.9

(51) Int. Cl. B26B 19/38

(52) U.S. Cl. CPC B26B 19/3853

(57) ABSTRACT

The invention relates to a personal care device such as a hair cutter or electric shaver, comprising a handle, a working head pivotably attached to said handle, a slider which is provided with a supplementary working tool such as a longhair trimmer and slidably attached to said handle to slide between an inactive parking position and an active working position for working with the supplementary working tool, and sliding controller for holding said slider in said inactive parking position and/or in said active working position and/or in at least one intermediate position. The sliding controller is configured to hold the slider in said at least one intermediate position only.

### FIELD OF THE INVENTION

The present invention relates to a personal care device such as a hair cutter or an electric shaver, comprising a handle, a working head pivotably attached to said handle, a slider which is provided with a supplementary working tool such as a long hair trimmer and slidably attached to said handle to slide between an inactive parking position and an active working position for working with the supplementary working tool, and a sliding controller for holding said slider in said inactive parking position and/or in said active working position and/or in at least one intermediate position.

### BACKGROUND OF THE INVENTION

Hair removal tools such as electric shavers or epilators often include working heads which may swivel relative to the handle to allow for adaption of the hair removal tool to the skin surface and to avoid angular misalignment. Such hair removal tools may include short hair cutters like perforated shear foils cooperating with a cutter blade movable under the shear foil, medium or long hair trimmers like a pair of comb-like cutting blades reciprocating relative to each other or hair-pulling tools for clamping and pulling hairs out of the skin. To achieve the cutting, pulling and/or removal action, the removal tools may be driven by a motor via a drivetrain to make the removal tool move in the desired way, wherein the way of moving may depend on the type of removal tool. For example, the cutter blades of elongated shear foil cutters may reciprocate along a linear axis parallel to the skin contact surface and the longitudinal axis of the elongated cutting blade, whereas rotatory shear foil cutters may continuously rotate or rotatorily oscillate about a rotation axis substantially perpendicular to the skin surface. Medium or long hair trimmers comprising comb-like cutters may reciprocate, similar to elongate shear foil cutters, along the longitudinal comb axis parallel to the skin surface, and epilator tools for pulling out hairs may rotate about an axis of rotation substantially to the skin contact surface.

The swivel axis may be arranged substantially parallel to the skin contact surface of the working head and thus, transverse to the major extension axis of the drivetrain and more particularly, transverse to the longitudinal axis of the handle part of the drivetrain. When the removal tools include an elongated shear foil cutter and/or an elongated trimmer, the swivel axis may extend substantially parallel to the longitudinal axis of such elongated removal tools and thus, substantially parallel to the linear oscillation of the removal tool to be generated by the drivetrain.

In other examples, the working head may pivot about a pivot axis which is also parallel to the skin contact surface of the working head and transverse to the longitudinal axis of the handle, but substantially transverse to the aforementioned longitudinal axis of the elongated removal tools and/or substantially parallel to the linear oscillation of the removal tool, wherein, in some other examples, the working head may pivot and swivel relative to the handle.

While such pivotable support of the working head improves contour adaption, nevertheless, some users appreciate the option to have the working head held in a specific orientation relative to the handle and have the swiveling movements blocked. So as to allow locking or blocking or holding the working head in a specific swiveling/pivoting position relative to the handle, a holding brake may be provided, wherein such holding brake may be switchable from an active holding configuration to an inactive release configuration and vice versa so as to offer the user both options. When the holding brake is inactive or released, the working head is freely pivotable relative to the handle or may pivot relative to the handle with a rather low resistance, whereas in the active configuration of the holding brake, the working head is held in one of a plurality of swivel/pivoting positions relative to the handle.

Depending on the configuration of the holding brake, the working head may be completely locked relative to the handle so swiveling/pivoting is not possible or is held in the specific angular position only as long as normal working loads and/or working torques are applied onto the working head, but swiveling/pivoting is possible when applying extraordinary loads and/or torques onto the working head. Such holding of the working head with a limited braking torque and/or braking force is preferred by some users who like to lock the working head, i.e. prefer to activate the holding brake, before adjusting the working head into the desired angular orientation relative to the handle.

For example, EP 2591889 A1 discloses an electric shaver having a working head supported pivotably relative to the handle about a swivel axis, wherein swiveling of the working head may be locked or braked by means of a holding brake which includes a U-shaped spring forming an engaging element to be engaged with the working head, wherein said U-shaped spring is biased towards the engaging/braking position and may be released by means of a slider that is slidably supported on a side of the handle opposite to another slider supporting a long hair trimmer of the electric shaver. As the slider for activating the holding brake is on a front side of the handle and the slider with the long hair trimmer is on a backside of the handle, it is usually the thumb that grips the frontside slider, whereas the other fingers are positioned on the backside slider. When gripping the handle with the thumb on one side and the other fingers on the other side of the handle, sliding action of one of the sliders may, however, unintentionally lead to sliding action of the opposite slider. Furthermore, the entire handle may unintentionally move relative to the hand gripping the handle when placing the thumb on one slider and the other fingers on the other slider.

More particularly, the slider supporting an accessory or supplementary working tool such as a long hair trimmer usually has a rather long sliding way between its inactive parking position and its active working position. In the parking position of the supplementary tool, the working head with the main working tools should be unobstructed and freely accessible to allow for working with the working head without interference with the supplementary tool. Therefore, in the parking position, the supplementary tool is retracted below the working head and/or not projecting beyond the handle towards the working head so only the working head is projecting from the handle's longitudinal end portion. On the other hand, when the supplementary tool is used, it is desired to have the supplementary tool in a position projecting beyond the working head, thereby necessitating a rather long sliding distance between the inactive parking position and the active working position of the slider supporting the supplementary tool.

Another example of an electric shaver showing a slider supporting a long hair trimmer and slidable from an inactive parking position to an active working position and vice versa, is shown by EP 0649711 A1.

### SUMMARY OF THE INVENTION

It is an objective underlying the present invention to provide for an improved personal care device such as an electric hair trimmer avoiding at least one of the disadvantages of the prior art and/or further developing the existing solutions.

A more particular objective underlying the invention is to provide for an improved handling of the personal care device avoiding unintentional switching between the personal care device's configurations and providing for a better grip onto the handle.

A further objective underlying the invention is to provide for a personal care device having an improved holding brake for holding the working head in a desired angular position with a well-defined holding resistance without sacrificing easy switching of the holding brake.

To achieve at least one of the aforementioned objectives, it is suggested to control the slider supporting the supplementary tools such as a longhair trimmer, in its sliding motion by means of a sliding controller that is working or operating in different ways depending on the sliding direction of the slider. More particularly, the sliding controller may be configured to hold the slider in at least one intermediate position which is between the slider's parking position and the slider's working position only when approaching such at least one intermediate position from a first side and/or in a first sliding direction, but to not hold the slider in the intermediate position when approaching the intermediate position from a second side opposite to the first side and/or in a second sliding direction opposite to the first sliding direction.

More particularly, the sliding controller may be configured to hold the slider in said at least one intermediate position when coming from the parking position and approaching the intermediate position when sliding from the parking position towards the active working position, whereas on the other hand the slider is not held or trapped in said intermediate position when coming from the active working position and/or when sliding from the active working position towards the parking position.

In other words, the sliding controller may have a directional configuration to operate in different ways depending on the sliding direction and/or may be activated in or around the slider's intermediate position depending on the direction of approaching such intermediate position.

More particularly, said sliding controller may include a latching mechanism for latching the slider in said intermediate position, wherein said latching mechanism includes a movable latching element which is supported movably into and out of engagement with a cooperating latching contour along a latching direction transverse to the sliding direction of the slider. Thus, said latching element may move transverse to the sliding direction to get into and out of engagement with the cooperating latching contour, wherein one of said latching element and said latching contour follows the sliding motion of the slider and/or is attached to the slider so it is moved in the sliding direction when the slider is moved in the sliding direction. The other one of said latching element and said latching contour is restricted with regard to such sliding movements, i.e. is blocked against sliding movements and/or may be moved in the sliding direction only to a limited extent. Thus, when the latching element and the latching contour get into engagement with each other due to transverse movement of the latching element, the intermediate position is defined and held.

So as to achieve directionally different behavior of the latching mechanism, a restrictor may be provided for restricting movements of the latching element in said transverse direction, wherein in particular such restrictor may hold the latching element back in a non-latching position and/or prevent transverse movement of the latching element to get into engagement with the cooperating latching contour. Such restrictor may be configured to become active only when the slider is moved along its sliding path in one direction, whereas the restrictor is prevented from becoming active when moving the slider along the sliding path in the opposite direction.

Such sliding controller may come along with a double function of the slider supporting the supplementary working tool such as a longhair trimmer, which double function may include on the one hand, bringing the supplementary tool from its inactive parking position to its active working position and vice versa, and, on the other hand, activating and deactivating the holding brake for holding the swiveling/pivotable working head in a desired angular position relative to the handle. More particularly, the slider supporting the supplementary tools such as a longhair trimmer, may be configured to activate and deactivate the holding brake when sliding along its sliding path relative to the handle. Depending on the position of the slider supporting the supplementary tool, the holding brake is either activated or deactivated. In particular, the slider may be provided with an actuating contour for actuating the holding brake when the slider is in an intermediate position between said parking position and said working position and for releasing said holding brake when the slider is in said parking position. In such intermediate position of the slider, the supplementary tool still may be inactive and/or in a position not obstructing the access to the working head so as to allow use of the working head without interference with the supplementary tool in a way similar to the slider being in its parking position. In other words, the intermediate position of the slider may be close to the parking position or at least closer to the parking position than to the working position so the working head may be locked or held in a desired angular position but nevertheless may be used without being unduly obstructed by the supplementary tool supported by the slider.

These and other advantages become more apparent from the following description giving reference to the drawings and possible examples.

### BRIEF DESCRIPTION OF THE DRAWINGS

FIGS. 1a, 1b and 1c: show perspective views of a personal care device in terms of an electric shaver, having a working head pivotably supported about a swivel axis relative to a handle and a slider supporting a supplementary tool in terms of a longhair trimmer and slidable relative to the handle along a sliding axis, wherein partial view of FIG. 1a shows the slider in its inactive parking position, partial view of FIG. 1b shows the slider in an intermediate position in which the working head is locked in an angular position relative to the handle, and partial view of FIG. 1c shows the slider in an active working position for using the supplementary tool in terms of the longhair trimmer and the working head being locked as in the intermediate position,

FIGS. 2a, 2b and 2c: show perspective views of the personal care device similar to FIGS. 1a, 1b and 1c, wherein the slider has been removed to show the holding brake including the engaging element thereof and a sliding controller for controlling sliding of the slider and holding the slider in the intermediate position, wherein partial view of FIG. 2a shows the holding brake in its released configuration and the sliding controller in parking position, partial view of FIG. 2b shows the holding brake in its braking/locking configuration and the sliding controller in its holding intermediate position to hold the slider in the intermediate position, and partial view of FIG. 2c shows the holding brake in its braking/holding configuration and the sliding controller in its active working position to hold the slider in its active working position,

FIGS. 3a and 3b: show enlarged partial, perspective views of the personal care device of FIGS. 1a, 1b and 1c, showing the holding brake between the handle and the working head, wherein partial view of FIG. 3a shows the engaging element of the holding brake in a released position disengaged from the working head and partial view of FIG. 3b shows the engaging element of the holding brake in a braking position engaged with the working head,

FIGS. 4a, 4b, 4c, 4d: show front views of the personal care device, wherein partial views FIG. 4.a, FIG. 4b, FIG. 4c and FIG. 4d show the slider in different positions to illustrate that the slider is locked or braked in its intermediate position shown in partial view of FIG. 4b when being moved from the parking position shown by partial view FIG. 4a to the working position shown in partial view of FIG. 4c, whereas the slider is not locked/braked in its intermediate position when being moved from the working position shown by partial view of FIG. 4c to the parking position shown by partial view of FIG. 4.d,

FIGS. 5a and 5b: show perspective views of the sliding controller including a spring element having engagement portions to be engaged with a slider support on the one hand and the slider on the other hand with FIG. 5b being an enlarged partial view of FIG. 5a,

FIGS. 6a, 6b and 6c: show perspective views of the sliding controller of the personal care device showing cooperation of the engaging element of the sliding controller with a sliding controller contour of the slider, wherein partial view of FIG. 6a shows the sliding controller contour when the slider is in its parking position and partial view of FIG. 6b shows the sliding controller contour in braking/locking engagement with the engaging element when the slider has been moved in, from its parking position, into its intermediate position, and wherein partial view of FIG. 6c is an enlarged partial view of FIG. 6b showing the engaging element locked in a depression of the sliding controller contour of the slider to hold the slider in its intermediate position,

FIGS. 7a, 7b and 7c: show perspective views of the personal care device showing the sliding controller when the slider is in its working position with the FIGS. 7b and 7c (with some parts removed relative to FIG. 7b being enlarged partial views of FIG. 7a),

FIGS. 8a and 8b: show perspective views of the personal care device showing the sliding controller in an unlocking/released configuration when the slider coming from the working position has reached its intermediate position with FIG. 8b) being an enlarged partial view of FIG. 8a),

FIGS. 9a and 9b: show perspective views of the personal care device showing the sliding controller (without the slider housing part) when the slider coming from the intermediate position has reached its parking position with FIG. 9b being an enlarged partial view of FIG. 9a, and

FIGS. 10a and 10b: show perspective views of the personal care device showing the sliding controller holding the slider in its parking position with FIG. 10b being an enlarged partial view of FIG. 10a.

### DETAILED DESCRIPTION OF THE INVENTION

As illustrated by the drawings, the personal care device may include a slider supporting the supplementary tools such as a longhair trimmer, wherein such slider may be controlled in its sliding motion by means of a sliding controller that is configured to hold the slider in at least one intermediate position which is between the slider's parking position and the slider's working position only when approaching such at least one intermediate position from one side and/or in one sliding direction. More particularly, the sliding controller may be configured to hold the slider in said at least one intermediate position when coming from the parking position and approaching the intermediate position when sliding from the parking position towards the active working position, whereas on the other hand the slider is not held or trapped in said intermediate position when coming from the active working position and/or when sliding from the active working position towards the parking position.

In other words, the sliding controller may have a directional configuration to operate in different ways depending on the sliding direction and/or may be activated in or around the slider's intermediate position depending on the direction of approaching such intermediate position.

More particularly, said sliding controller may include a latching mechanism for latching the slider in said intermediate position, wherein said latching mechanism includes a movable latching element which is supported movably into and out of engagement with a cooperating latching contour along a latching direction transverse to the sliding direction of the slider. Thus, said latching element may move transverse to the sliding direction to get into and out of engagement with the cooperating latching contour, wherein one of said latching element and said latching contour follows the sliding motion of the slider and/or is attached to the slider so it is moved in the sliding direction when the slider is moved in the sliding direction.

The other one of said latching element and said latching contour is restricted with regard to such sliding movements, i.e. is blocked against sliding movements and/or may be moved in the sliding direction only to a limited extent. Thus, when the latching element and the latching contour get into engagement with each other due to transverse movement of the latching element, the intermediate position is defined and held.

So as to achieve directionally different behavior of the latching mechanism, a restrictor may be provided for restricting movements of the latching element in said transverse direction, wherein in particular such restrictor may hold the latching element back in a non-latching position and/or prevent transverse movement of the latching element to get into engagement with the cooperating latching contour. Such restrictor may be configured to become active only when the slider is moved along its sliding path in one direction, whereas the restrictor is prevented from becoming active when moving the slider along the sliding path in the opposite direction.

More particularly, the restrictor may include a catching jaw that opens towards one sliding direction and is closed towards the opposite sliding direction so as to catch the movable latching element when coming from one side and not catching and/or releasing the latching element when going into the opposite direction. More particularly, the jaw may open in the sliding direction in which the slider goes to the active working position and may be closed in the opposite sliding direction in which the slider goes to its inactive parking position. Thus, the catching chaw may catch the movable latching element when the slider is moved towards its parking position so as to restrict the latching element in the catching chaw to prevent the latching element from latching movements transverse to the sliding direction and holding it back in a non-latching position. On the other hand, when moving the slider in the opposite sliding direction, i.e. from the inactive parking position to the active working position, the latching element may exit the catching chaw and thereby gains additional freedom in the transverse direction so the latching element may move in the transverse direction to engage with the cooperating latching contour.

According to an aspect, the movable latching element may be guided in or by a trapping recess providing for limited movability of the latching element in the sliding direction and providing for limited movement of the latching element in the transverse direction, said trapping recess having two portions neighboring each other or space apart from each other in the sliding direction, wherein said two portions provide for different movability of the latching element in the transverse direction.

The movable latching element may be biased towards its latching position in which it is in engagement with the cooperating latching element to lock the slider into the intermediate position, wherein such biasing may be achieved by means of a spring element. More particularly, the spring element and the latching element may be integrated into each other and/or said latching element may be formed by a portion of the spring element.

More particularly, said spring element may include a first end portion attached to the slider so as to follow the slider when sliding along the sliding path thereof, and another end portion attached to the handle, or a carrier attached thereto. As one end portion is attached to the handle and the other end portion is attached to the slider, the spring element is subject to deformation when the slider is moved relative to the handle.

The aforementioned end portion attached to the handle may form the movable latching element and/or said movable latching element may be mounted to said end portion attached to the handle, wherein on the other hand the cooperating latching contour may be attached to the slider to follow sliding movements of the slider and thus, moving relative to the latching element in the sliding direction when the slider is moved relative to the handle.

More particularly, the latching contour attached to the slider may include a cam surface on which the biased latching element may ride when the slider is moved relative to the handle, wherein such cam surface may include a latching recess and/or a latching projection which may get into latching engagement with the movable latching element that is movable in the transverse direction, wherein said movable latching element may have a latching projection and/or a latching recess to cooperate with the latching contour.

The latching engagement of the latching element with the cooperating latching contour may completely lock the slider in the intermediate position or may provide for a stable resting position for the slider which may leave the resting position when a sufficiently large driving force is applied onto the slider in the sliding direction. For example, the latching element and the latching contour may provide for a sort of detent ball locking allowing the latching element to snap into the for example recessed latching contour which may have ramped or sloped entering and exiting surfaces to allow for releasing the latching engagement by means of sufficiently strong driving action in the sliding direction.

According to another aspect, the slider supporting the supplementary working tool such as a longhair trimmer, may have a double function. In addition to its basic function of transporting the supplementary tool from its inactive parking position to its active working position and vice versa when sliding along its sliding path relative to the handle, the slider is given the function of activating and deactivating the holding brake for holding the swiveling/pivotable working head in a desired one of a plurality of possible angular positions relative to the handle wherein such activating/deactivating of the holding brake may be effected without changing the working status of the supplementary tool mounted to the slider.

More particularly, the slider supporting the supplementary tools such as a longhair trimmer, is configured to activate and deactivate the holding brake when sliding along its sliding path relative to the handle. Depending on the position of the slider supporting the supplementary tool, the holding brake is either activated or deactivated.

In particular, the slider may be provided with an actuating contour for actuating the holding brake when the slider is in an intermediate position between said parking position and said working position and for releasing said holding brake when the slider is in said parking position. In such intermediate position of the slider, the supplementary tool still may be inactive and/or in a position not obstructing the access to the working head so as to allow use of the working head without interference with the supplementary tool in a way similar to the slider being in its parking position. In other words, the intermediate position of the slider may be close to the parking position or at least closer to the parking position than to the working position so the working head may be locked or held in a desired angular position but nevertheless may be used without being unduly obstructed by the supplementary tool supported by the slider.

The actuating contour may be configured to keep the holding brake activated when the slider is further moved along its sliding path from the intermediate position to the active position, so the working head is held in the adjusted angular position and prevented from undesired swiveling when the supplementary tool is in its working positon.

Depending on the type of supplementary tool, however, the actuating contour may be configured to release the holding brake again when the slider is further moved along its sliding path from the intermediate position to the active position so the working head may swivel when the supplementary tool is in its active working position. Such configuration may be desired, for example, when the supplementary tool is an applicator tool to apply an agent such as a lubricant or spray a cooling fluid onto the skin.

The aforementioned actuating contour of the slider may include a cam surface engaging with a cam follower attached to the holding break to urge the cam follower and, thus, the holding break into different positions depending on the sliding position of the slider. More particularly, such cam surface may include portions having extensions different from each other in a direction transverse to the sliding direction of the slider so that the cam follower is moved transverse to the sliding direction of the slider when coming into contact with said different portions of the cam surface of different transverse extensions.

More particularly, the cam surface may include at least one sloped portion being inclined at an acute angle relative to the sliding direction of the slider and/or at least one projection and/or recess which projects/is recessed relative to neighboring cam surface portions in a direction transverse to the sliding direction of the slider. The cam follower may ride such sloped portion or projection, or recess may when the slider is moving between its parking position and intermediate position to make the holding brake change its operating status from active to inactive and vice versa.

Said cam surface including the sloped portion and/or projection and/or recess may define a continuous shape such as a continuous curve along which the cam follower may slide or roll, wherein such continuous curve may include straight portions, wherein transitions from, for example, straight portions to curved portions or between two straight portions having different slopes relative to the sliding direction may be smooth and rounded. In the alternative, it is also possible to have bent or angled transitions between two straight portions of different slopes.

So as to allow for controlled movements of the cam follower in opposite directions transverse to the sliding direction, the cam surface may be a slot in which the cam follower is received, wherein such cam follower may include, for example, a pin or projection received in said slot, or a roller received in said slot. Such slot, with its opposite longitudinal surfaces, actually forms two cam surfaces, one of which urging the cam follower in a first direction transverse to the sliding direction of the slider and the other one urging the cam follower in a second direction opposite to said first direction. Due to such forced control or positive control of the cam follower of the break mechanism in both directions, activation and deactivation of the holding break may exactly follow the sliding movement of the slider. In particular, an actuating element of the holding brake is positively urged to release as well as urged to brake.

The aforementioned elongated slot may be formed in the slider and may have a longitudinal extension in the sliding direction of the slider which longitudinal extension is at least as long as the sliding path of the slider from its parking position to its working position so the cam follower may ride on the cam surface or in the cam slot over the entire sliding path of the slider.

In the alternative to the aforementioned configuration, it also should be considered to provide the slider with a pin or other projection or a roller to engage with an elongated cam surface formed at or attached to an actuating element of the break mechanism so that, when sliding the slider along its sliding path relative to the handle, the pin or roller or generally the projection attached to the slider may urge the actuating element of the holding break in a directions transverse to the sliding direction of the slider. However, a more compact arrangement utilizing the usually significant length of the slider can be achieved when the elongated cam surface is provided on the slider side and the cam follower formed by a pin or roller is formed at the break mechanism side.

More particularly, the holding break may include an actuating lever pivotably supported at the handle, or at a carrier attached to the handle, to pivot about a pivot axis relative to the handle, wherein such actuating lever may cooperate with the aforementioned actuating contour of the slider to pivot about said pivot axis in response to sliding of the slider.

Such actuating lever may be provided with the aforementioned cam follower riding the cam surface of the slider to cause pivoting of the actuating lever in response to sliding of the slider.

The pivot axis of the actuating lever may extend substantially perpendicular to the sliding direction of the slider. More particularly, the pivot axis may extend substantially perpendicular to the sliding direction and substantially perpendicular to the side or surface of the handle on which the slider is arranged. For example, when the slider supporting the supplementary tool is provided on the backside of the handle, the pivot axis may extend substantially perpendicular to the backside surface of the handle. The handle may have a substantially rounded contour and/or may have free form surfaces to allow for a natural grip and to adapt to the contour of a gripping hand, wherein in such case the pivot axis of the actuating lever may extend transverse or substantially perpendicular to a virtual plane tangential to the backside surface of the handle on which the slider is provided.

In addition, or in the alternative, the pivot axis may extend substantially perpendicular to a gripping surface of the slider or a virtual plane tangential to said gripping surface of the slider.

The aforementioned actuating lever may be supported at an end portion of the handle neighboring the working head and/or may have an actuating portion which, in the active angular position of the actuating lever urging the holding brake into its braking configuration, projects beyond the end portion of the handle facing the working head so as to urge an engaging element of the holding brake towards the working head.

So as to support large reaction forces coming from the holding brake's engaging element in the locking/braking position without transmitting such large forces onto the slider's actuating contour, the actuating lever and the pivot axis thereof may be arranged such that the actuating lever, in its active braking position, is in a rather steep orientation and/or a position in which the reaction forces onto the actuating lever have no or a rather small lever arm relative to the pivot axis of the actuating lever. More particularly, a virtual line going through the pivot axis and the point of contact where the actuating lever contacts the engaging element of the holding brake, may be substantially parallel to—or inclined at an angle smaller than 25° or 15° or 5° to—the direction of the reaction force applied to the actuating lever from the holding brake's engaging lever. For example, the support arm of the actuating lever supporting the holding brake's engaging element in the active braking position, may be substantially perpendicular to an arm of the holding brake's engaging element supported by said actuating lever.

The engaging element of the holding brake which engages the working head to hold the angular position thereof, may include a spring which may be configured to provide for biasing of the holding brake towards the inactive, released configuration so the biasing force of the spring needs to be overcome to make the holding brake hold the working head and make the engaging element of the holding brake engage the working head in a manner to block swiveling of the working head. The biasing pretension of the spring may be used to get the holding brake into its released configuration when the slider does not actuate the holding brake, i.e. when the slider is for example in its parking position.

Using the spring force or spring torque to deactivate the holding brake and urging the engaging element of the holding brake into its braking position by means of the slider overcoming the biasing pretension of the spring, allows for more precise control of the braking action and a stiffer positioning of the engaging element of the holding brake in its active braking position. It is no longer only the biasing force of the spring that controls the braking engagement—as it would be the case when biasing the holding brake into its active braking position and releasing the brake by means of an actuator overcoming such biasing—, but the holding brake is held in its holding position in a substantially non-elastic manner. More particularly, the engaging element of the holding brake, in its active braking position engaging the working head, may be supported against the actuating contour of the slider, and/or reaction forces and/or torques onto the engaging element of the holding brake in its active position may be transmitted onto the handle and to some extent onto the actuating contour of the slider, in a substantially non-elastic way, in particular without transmitting it via a spring, but only via substantially rigid elements.

A substantially rigid drive train for urging the holding brake into its active locking position and holding it in said active locking position may be provided, wherein such drive train may be formed by the aforementioned actuating element movably supported at the handle or a carriage attached thereto and held in position by the actuating contour of the slider. In the active braking configuration, such “drive train” forms a sort of rigid or stiff framework supporting the holding brake's engaging element and holding it in position and transmits the reaction forces into the handle. More particularly, such drive train may be formed by the aforementioned actuating lever which may transfer a major portion of the holding forces of the holding brake's engaging element directly into the handle or a carrier attached thereto and a minor portion of such holding forces into the actuating contour of the slider, in particular into the cam surface of the slider controlling the rotatory position of said actuating lever.

More particularly, the engaging element of the holding brake, in its active braking position, may be supported against the handle and, to some extent depending on the position of the actuating lever, against the actuating contour of the slider via the aforementioned actuating lever which may contact, on the one hand, the actuating contour of the slider and, on the other hand, the engaging element of the holding brake. Via its pivot axis, the actuating lever may transfer forces into the handle. The actuating lever may directly connect the slider to the engaging element of the holding brake.

In case of the aforementioned cam surface and cam follower configuration, the actuating lever may contact the engaging element of the holding brake and receive reaction forces therefrom on the one hand and may contact the cam surface of the slider and transmit the reaction forces thereto.

The engaging element of the holding brake and the aforementioned spring for urging the holding brake into its released configuration may be integrated into each other and/or together may form an elastic engaging element. For example, the engaging element may have a substantially U-shaped configuration including a first leg attached to the handle and a second leg forming an engagement portion to engage the working head, wherein said two legs and/or an intermediate leg connecting the aforementioned two legs may be elastically deformed so as to move the engaging portion towards and away from the working head. More particularly, the elastic U-shaped element may be attached to the handle so that the leg with the engaging portion is separated from the working head in a natural or undisplaced home position into which the leg with the engaging portion moves without being activated by the slider. When the slider is moved into the intermediate position, however, the leg with the engaging portion is urged, in particular by means of the aforementioned activating lever, towards the working head to engage the braking contour of the working head.

For example, the working head may be provided with a braking contour extending along an arch or circle around the pivot axis of the working head, wherein such braking contour may have a ripped structure or grid structure including projections and depressions cooperating with the engagement element of the holding brake. For example, the aforementioned elastic, in particular U-shaped engaging element of the holding brake may be provided with a projection projecting towards the working head and cooperating with the aforementioned projections and depressions of the braking contour of the working head.

For example, the braking contour of the working head may form a toothed profile allowing for latching with the engaging element of the holding brake. More particularly, the engaging element of the holding brake may be provided with projection or a tooth which may engage with a recess between two neighboring teeth of the braking contour of the working head.

Said toothing may extend along an arc or circle around the pivot axis of the working head.

In the alternative or in addition to such toothed profile on the working head, the engaging element of the holding brake to be moved towards and away from the working head may be provided with a toothed profile to cooperate with a projection such as a tooth provided on the working head.

As can be seen from the figures, the personal care device 1 may be formed as a hair cutting device or an electric shaver 2 and may have, irrespective of its specific configuration, an elongated handle 3 to be gripped by a user's hand, in particular between the fingers and the thumb of a hand of a user, and furthermore a working head 4 attached to said handle 3.

The handle 3 may form a housing in which components such as a power unit for example in terms of a battery or accumulator, a controller in terms of for example a board with integrated circuits, and a drive unit in terms of for example an electric motor may be accommodated. As can be seen from the figures, the handle 3 may have an elongated, roughly speaking cylindrical or bone-shaped configuration including rounded surfaces to allow for comfortably gripping of the handle.

The working head 4 may include a primary working tool for effecting the main function of the personal care device 1. For example, the working head 4 may include at least one hair cutting tool 5 such as a shear foil cutter and/or a shorthair or longhair cutter such as a comb-like shearing bar.

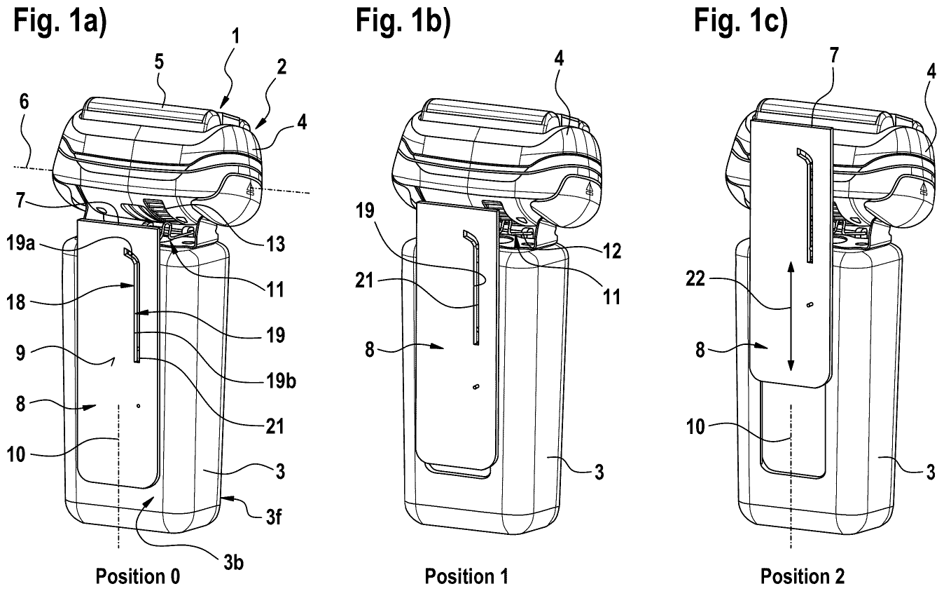

The working head 5 may be pivotably supported at one end portion of the handle 3 to swivel about a pivot axis 6. For example, the working head 4 may have a block-like elongated configuration, for example similar to an elongated cube or box, and may have a main axis along which it has its longest extension, wherein such main axis of the working head 4 may extend substantially perpendicular to the longitudinal axis 10 of the handle 3, cf. FIG. 1. In such case of an elongated box-like working head 4, the aforementioned pivot axis 6 may extend substantially parallel to the major axis of the elongated, cube-like working head 4, cf. FIG. 1. Thus, the pivot axis 4 may extend substantially perpendicular or transverse to the longitudinal axis 10 of the handle 3.

Irrespective of the shape of the working head 4, the pivot axis 6 may extend transverse to the longitudinal axis of the handle 3 and substantially parallel to a virtual plane tangential to a backside 3b or a front side 3f of the handle 3, wherein a front side 3f of the handle 3 is usually gripped by a thumb and a backside 3b of the handle 3 is usually gripped by the fingers of a hand. For example, a front side of the handle 3 may be provided with a display for displaying information to the user and/or an on-/off-switch for switching on and switching off the personal care device 1. Furthermore, the backside 3b of the handle 3 may have a contour adapted to the fingers at the inner side of a gripping hand.

In addition to the aforementioned working head 4, the personal care device 1 is provided with a supplementary tool 7 for effecting an additional or accessory function of the personal care device 1. For example, the supplementary tool 7 may be a longhair trimmer in case the personal care device 1 is a hair cutter. In the alternative, the supplementary tool 7 may include an applicator for applying a liquid or a cream-like substance onto the skin of a user or onto the working head 4.

The supplementary tool 7 may include other types of tools such as a lighting device or an ultrasonic transducer to apply ultrasonic waves onto tissue.

In the figures, position 0 corresponds to a parking position of the slider and the working head being able to freely swivel—not obstructed by a head lock mechanism. The supplementary tool 7 as e.g. the long hair trimmer of the slider is not activated in that parking position. Positions 1 and 2 in the figures show the head being hold, locked or blocked or in a braking position, i.e. the head can no longer swivel and is kept in a neutral or a specific angled swivel position. Position 1 stands for an intermediate slider position in which the supplementary tool is still not activated and in position 2 the end stop position of the slider is reached with the supplementary tool being switched on/activated.

As can be seen from FIG. 1, the supplementary tool 7 is supported by or attached to a slider 8 which is slidably supported on the handle 3, wherein the slider 8 may form a part of the outer surface of the handle 3 or cover an outer surface of the handle 3. More particularly, the slider 8 may have a substantially plate-like body forming a sort of shield covering a part of the handles 3 outer surface.

Irrespective of its shape, the slider 8 may have a gripping surface 9 to be gripped by a hand of the user gripping the handle 3. In particular, the gripping surface 9 may be positioned and configured to be gripped by the fingers or a thumb of a hand of the user.

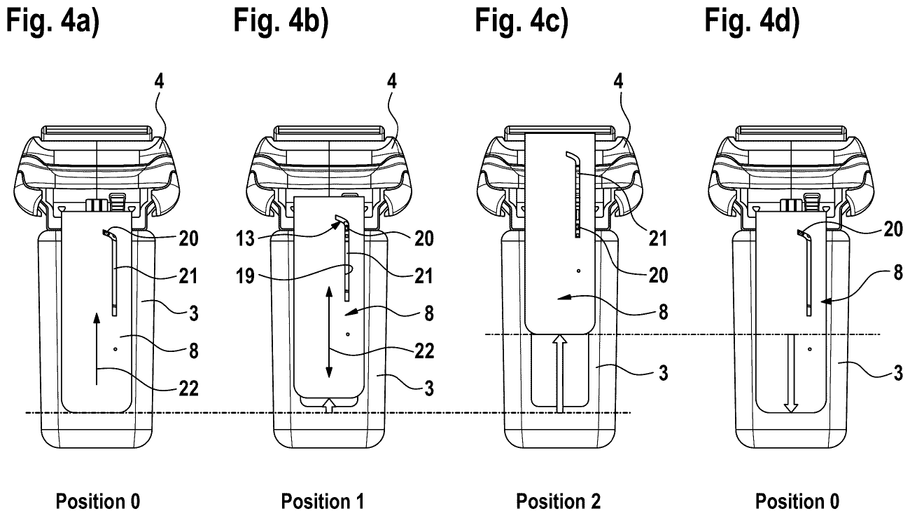

For example, the slider 8 may be arranged on the aforementioned backside 3b of the handle 3 opposite to a front side 3f on which a display or an on-/off-switch may be provided cf. FIGS. 1 and 4.

The slider 8 is supported to be displaced relative to the handle 3 along a sliding path substantially parallel to the longitudinal axis 10 of the handle 3, wherein such sliding path may be straight or slightly curved.

More particularly, the sliding path of the slider 8 may be configured to allow the supplementary tool 7 to be moved from a parking position that is shown in FIG. 1a to a working position shown in FIG. 1c. In the parking position of the slider 8, the slider 8 substantially extends on the outer surface of the handle 3 and substantially does not project beyond the end portion of the handle 3 facing the working head 4. More particularly, the supplementary tool 7 which may be positioned on an end portion of the slider 8, may be retracted from the working head 4 and/or may be positioned neighboring an end portion of the handle 3 and substantially not projecting beyond the handle 3 towards the working head 4, cf. FIG. 1a.

In the active working position of the slider 8, the slider 8 and in particular the supplementary tool 7 may project beyond the end portion of the handle 3 facing the working head 4 so that, when viewing the personal care device 1 in a direction perpendicular onto the slider side of the handle 3 and/or perpendicular to the gripping surface 9 of the slider 8, the slider 8 may overlap with the working head and/or cover a substantial portion of the working head 4, cf. FIG. 4c. For example, the supplementary tool 7 may be positioned at a height—when considering the longitudinal axis 10 of the handle 3 to define the height direction—similar to or substantially the same as the height of the tools of the working head 4 and/or the skin contact surface of the working head 4, cf. FIGS. 1c and 4c. In contrast, when being in the parking position, the slider 8 and the supplementary tool 7 may overlap only the handle 3, when viewing the personal care device 1 in said viewing direction perpendicular onto the slider 8, cf. FIGS. 4a and 4d.

As illustrated by the figures, the personal care device 1 is provided with a holding brake 11 for holding the working head 4 in a desired one of the plurality of possible swivel positions of the working head 4 relative to the handle 3. In other words, the holding brake 11 brakes pivoting/swiveling movements of the working head 4 to prevent undesired swiveling/pivoting.

The holding brake 11 includes an engaging element 12 which is attached to or supported by the handle 3, wherein said engaging element 12 may be moved towards the working head 4 to be engaged therewith and may be moved away from the working head 4 to release the holding action of the holding brake 11.

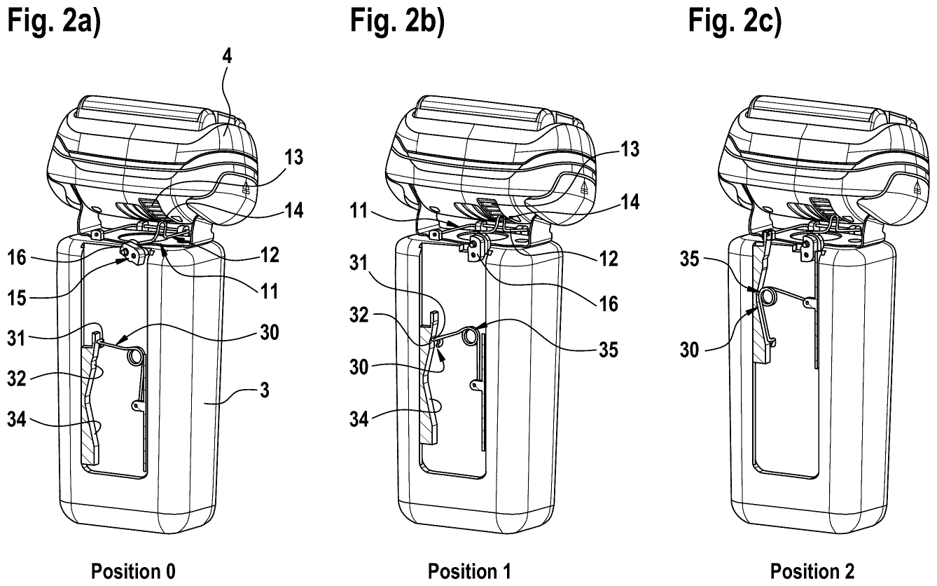

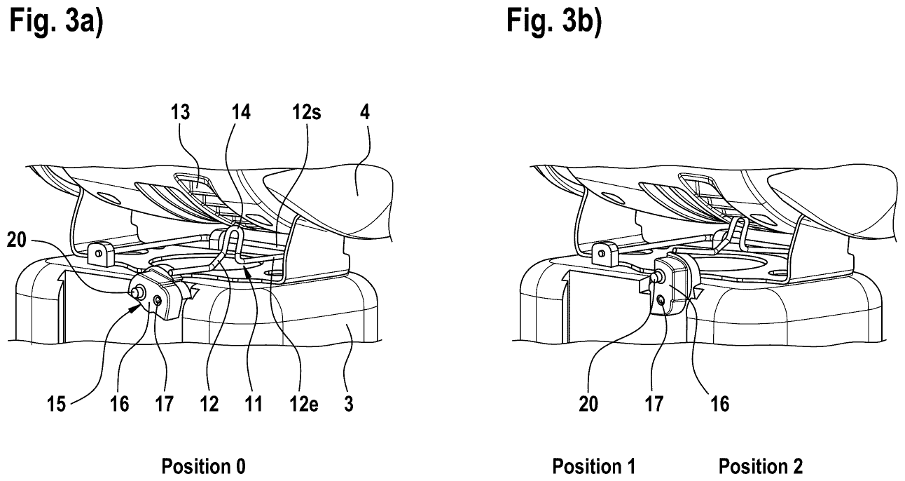

As can be seen from FIG. 2 and FIG. 3, the engaging element 12 may have a substantially U-shaped configuration including a supporting leg 12s which is supported at or attached to the handle 3, in particular the end face of handle 3 facing the working head 4, and furthermore a displaceable engaging portion 12e that can be moved towards and away from the working head 4 to be engaged with and disengaged from the working head 4.

For example, the substantially U-shaped engaging element 12 may be a spring or may be formed from elastic material such as an elastic wire, wherein the supporting portion or supporting leg 12s may be rigidly fixed to the handle 3 and the displacement of the engaging portion or engaging leg 12e may be effected by means of elastic deformation of the supporting and/or engaging legs 12s, 12e. In the alternative, however, it also would be possible to have a substantially rigid engaging element 12 wherein in such case the engaging element 12 could be movably supported, in particular pivotably supported at the handle 3 to allow for moving the engaging portion 12e to approach the working head 3 and be moved away therefrom.

As can be seen from FIG. 3, the working head 4 may be provided with a braking contour 13 to be engaged with the engaging element 12 of the holding brake 11, wherein said braking contour 13 may extend along an arch or a circle around the pivot axis 6 of the working head 4 so that the braking contour 13, when swiveling the working head 4 about pivot axis 6, passes the engaging portion 12e of the engaging element 12 with different portions of the braking contour 13 having substantially the same distance from said engaging portion 12e.

More particularly, the braking contour 13 may include a tooth profile including a plurality of projections and recesses in a row along the extension of the braking contour 13 and thus, offering a plurality of locking or latching positions for the working head 4.

So as to cooperate with said braking contour 13, the engaging portion 12e of the engaging element 12 may be provided with a tooth or projection 14 which may cooperate with the tooth profile of the braking contour 13. In particular, the projection 14 may enter into a recess between a pair of neighboring projections of the braking contour 13 to achieve latching between the working head 4 and the engaging element 12, thereby holding the working head 4 in a desired swivel position.

Depending on the contour, in particular the slope of the teeth of the braking contour 13 and the slope of the side surfaces of the projection 14 of the engaging element 12, latching of the working head 4 in a specific angular position may be overcome or may be not overcome or may be overcome at different actuating forces trying to swivel the working head 4.

The engaging element 12 may be configured to have a home position of the engaging portions 12e in which home position the engaging portion 12e is disengaged from the working head 4 and does not brake swiveling of the working head 4. In such home position, the elastic engaging element 12 may be unbiased or relaxed. In the alternative, the engaging element 12 may be biased in the home position, wherein the engaging element 12 may be configured to increase clastic deformation and/or biasing when the engaging portion 12e moves towards the working head 4. In other words, the engaging element 12 is configured to provide for biasing of the engaging portion 12e towards its inactive, non-braking home position, wherein in such home position, it still may be elastically deformed to some extent so as to make sure that the engaging element 12e indeed reaches its home position and does not show undesired shaking or wobbling in the home position.

Although the figures show an elastic engaging element 12 providing for the aforementioned biasing action by itself, it also would be possible to provide for a substantially rigid engaging element 12, for example in terms of a pivotably supported braking lever, wherein in such case biasing could be provided by a separate spring element urging the engaging portion towards its home position disengaged from the working head 4.

As can be seen from FIGS. 2 and 3, the engaging element 12 of the holding brake 11 is actuated by means of an actuating element 15 which is movably supported at the handle 3 and/or a carrier attached to the handle 3. Said actuating element 15 may be configured to actively urge the engaging element 12 into its active braking position engaged with the working head 4, wherein the actuating element 15 may contact the engaging portion 12e of the engaging element 12 to push it against the working head 4. On the other hand, when the actuating element 15 retracts into its inactive position, the engaging element 12 is allowed to move away from the working head 4, wherein such removing of the engaging element 12 from the working head 4 may be effected by the aforementioned biasing and/or the elastic forces of the spring.

The actuating element 15 is supported at the handle 3 or a carrier attached thereto, to allow for displacement of the actuating element 15 towards and away from the working head 4. In particular, the actuating element 15 may have an inactive position not projecting beyond the end portion of the handle 3 and/or contacting the engaging element 12 in the home portion thereof and may move into an active braking position in which the actuating element 15 projects from the end portion of the handle 3 and/or contacts the engaging element 12 in the active braking position thereof.

As can be seen from FIG. 3, the actuating element 15 may include an actuating lever 16 which is pivotably supported at the handle 3 or a carrier attached thereto, about a pivot axis 17 substantially transverse to the longitudinal axis 10 of the handle 3 and/or substantially transverse to the sliding path of the slider 8 and/or substantially transverse to the gripping surface 9 of the slider 8 and/or substantially transverse to the pivot axis 6 of the working head 4.

When comparing partial views, a and b of FIG. 3, it can be seen that the actuating lever 16 projects from the end portion of the handle 3 towards the working head 4 a further distance when being in the active braking position shown by partial view b in comparison to the inactive, non-braking position shown in partial view a of FIG. 3.

The actuating element 15, in particular actuating lever 16 is displaced or moved by means of sliding the slider 8.

In particular, the slider 8 is provided with an actuating contour 18 for actuating the holding brake 11 wherein such actuating contour 18 may engage or contact the actuating element 15 to convert sliding movements of the slider 8 into actuating movements of the actuating element 15 and thus, into movements of the engaging element 12 of holding brake 11.

As can be seen from FIG. 1 and FIGS. 4, the actuating contour 18 of the slider 8 may include a cam surface 19 on which a cam follower 20 attached to the actuating element 15 rides when the slider 8 is moving along its sliding path.

For example, the slider 8 may be provided with a cam slot 21 providing for a pair of substantially parallel cam surfaces 19 between which the cam follower 20 is received. Such cam slot 21 extends along the slider 8 substantially parallel to the sliding path, but not exactly parallel and including at least one sloped portion and/or at least one transversely projecting portion and/or at least one transversely recessed portion. In particular, when considering the pivot axis 17 of actuating lever 16, the cam surface 19, in particular cam slot 21, includes portions passing the pivot axis 17 at different distances therefrom so that the cam follower 20 riding cam surface 21 or riding in cam slot 21 causes the actuating lever 16 to rotate about pivot axis 17, cf. FIGS. 1 and 2 in combination with FIG. 3.

More particularly, as can be seen from FIG. 1 and FIG. 4, the cam surface 19—or cam slot 21—may include a sloped portion 19a which is inclined at an acute angle relative to the sliding direction 22 of the slider 8, wherein said sloped portion 19a is in engagement with or cooperating with the actuating element 15, in particular the cam follower 20 attached thereto, when the slider 8 is between its inactive parking position, cf. FIG. 1a and FIG. 4a. Said sloped portion 19a is configured such that the actuating lever 16 is held or urged into its inactive, non-braking position, when the slider 8 is completely in its inactive parking position as shown by FIGS. 1a and 4a, wherein the sloped portion 19a starts to pivot the actuating lever 16 when the slider 8 is starting to move out of its parking position towards the intermediate position which is shown in FIGS. 1b and 4b. When the slider 8 is in the intermediate position, the actuating lever 16 has been pivoted into its active, braking position as shown by FIG. 2b.

As can be seen from FIGS. 1 and 4, the cam surface 19—and the cam follower 20—has a straight portion 19b neighboring said sloped portion 19a, wherein said straight portion 19b is substantially parallel to the sliding direction 22 so that the slider 8 may be moved further from the intermediate position shown in FIGS. 1b and 4b to the active working position shown by FIGS. 1c and 4c. Due to the straight portion 19b, the actuating lever 16 is not pivoted any further, but caped into the active braking position all the way of the slider 8 into its active working position. However, as mentioned earlier, it would be possible to give the cam surface 19 or the cam slot 21 a different curvature or configuration when it is desired to not have the actuating lever 16 in its active braking position when the slider 8 is in its active working position. For example, another sloped portion could be provided towards the other end of the cam slot 21 to bring the actuating lever 16 back into its non-braking position.

The sliding movement of the slider 8 along its sliding path is controlled by means of a slider controller 30 which is configured to elastically hold the slider 8 in its parking position as well as in its working position. More particularly, the sliding controller 30 may have a bistable configuration elastically urging the slider 8 into its parking position when approaching the parking position and furthermore, elastically urging the slider 8 into its working position when approaching the working position.

In addition, or in the alternative to such configuration for holding the slider 8 in its parking position and/or in its working position, the sliding controller 30, according to another aspect, is configured to hold the slider 8 in the aforementioned intermediate position that is shown in FIG. 1b and FIG. 4b.

More particularly, the sliding controller 30 may be configured to hold the slider 8 in said intermediate position only when coming from the parking position and/or when sliding towards the working position, whereas the slider 8 is not held in the intermediate position when the slider approaches said intermediate position in the opposite sliding direction towards the parking position and/or when coming from the working position. Such directionally different configuration of the sliding controller 30 is illustrated by FIG. 4, in particular partial view b in comparison to partial views c and d of FIG. 4. In particular, when moving the slider 8 from the parking position shown in FIG. 4a towards the working position shown in FIG. 4c, the sliding controller 30 provides for latching action and/or a holding force when the slider 8 is in the intermediate position shown in FIG. 4b. On the other hand, when moving the slider 8 from the working position shown in FIG. 4c to the parking position shown in FIG. 4d, the sliding controller 30 does not provide for any latching action and/or any holding force when passing the intermediate position.

As illustrated by FIGS. 2, 5 and 6, the sliding controller 30 may include a movable latching element 31 and a cooperating latching contour 32 which may engage with each other to hold the slider 8 in the intermediate position and/or to provide for a jamming or constraining force trying to stop the slider 8 in the intermediate position.

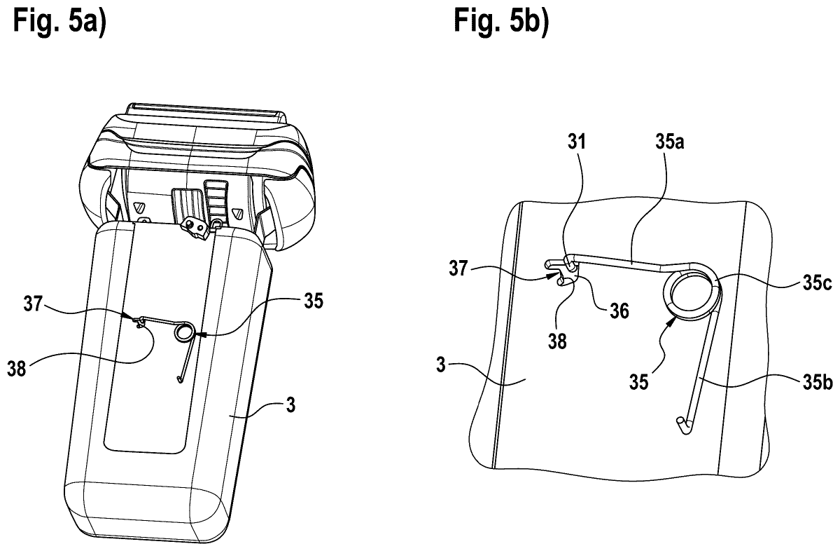

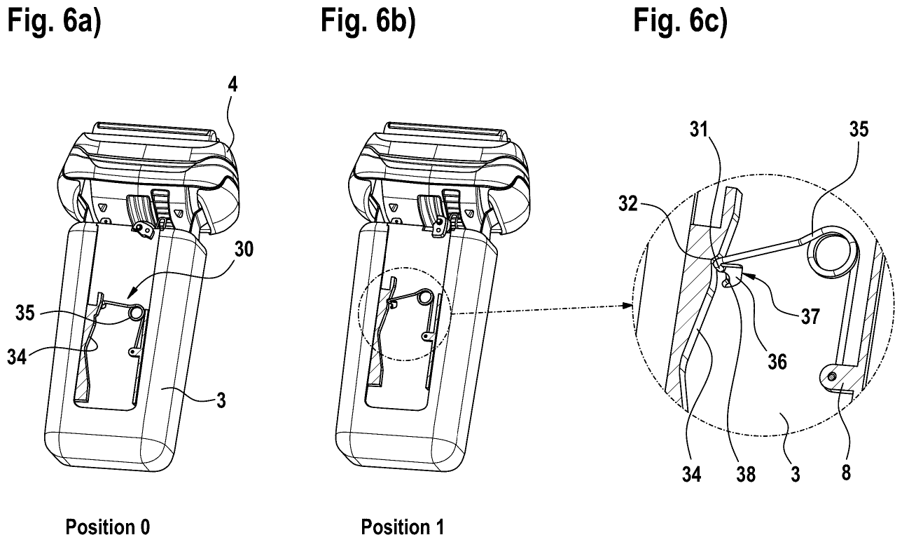

More particularly, the moving latching element 31 is supported movably in a latching direction 33, cf. FIG. 5 and FIG. 6c, which is transverse to the sliding direction 22 of the slider 8 and/or which is towards the cooperating latching contour 32.

For example, the latching contour 32 may include a recess or a depression which may have the shape of, for example, a V or a smoothened dint. On the other hand, the latching element 31 may include a latching projection and/or a latching contour fitting into the aforementioned recess of the latching contour 32 so that the latching element 31, when moving in said latching direction 33 towards the latching contour 32, may snap into the recess of the latching contour 32.

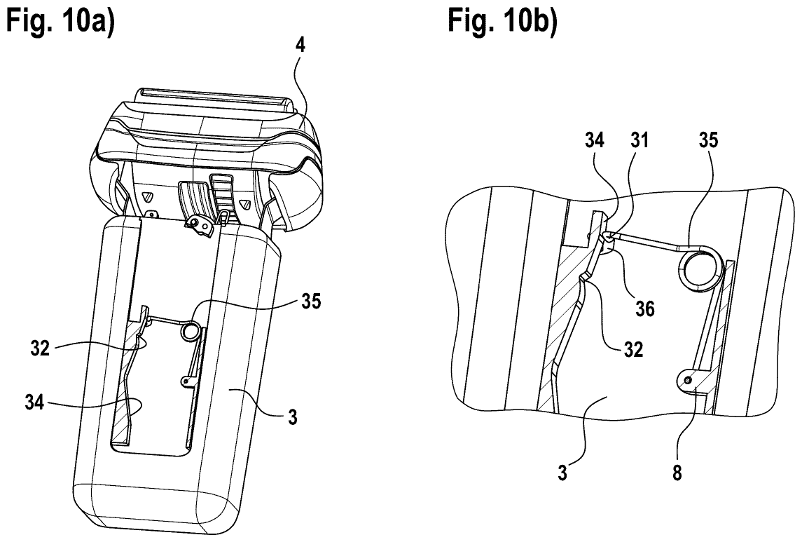

As illustrated by FIGS. 2 and 5 to 10, the latching contour 32 may be attached to the slider 8 and/or be formed by a part of the slider 8. Irrespective of this, the latching contour 32 may include a cam surface 34 on which the movable latching element 31 may ride when the slider 8 is moved along its sliding path. Said cam surface 34 may be formed at a longitudinal or lateral edge portion of the slider 8 and may include sloped portions and/or projections and/or recesses having different extensions in the direction transverse to the sliding direction 22, cf. for example FIG. 2.

The aforementioned latching contour 32 may be part of said cam surface 34, and in particular may form a recessed, for example V-shaped portion of the cam surface 34.

The latching element 31 may be biased in said transverse latching direction 33 towards its latching position in which it engages with latching contour 32, wherein, for example, a spring element may be connected to the latching element 31 to provide for such pretension towards the latching position.

More particularly, the latching element 31 may form part of a latching spring 35 of the sliding controller 30 which latching spring 35 may include two spring arms 35a and 35b which may bend relative to each other for example, by means of an elastic joint 35c connecting the two spring arms 35a and 35b to each other. In particular, said elastic joint 35c may form an integral part of the latching spring 35 and may be integrally, homogenously connected to said spring arms 35a and 35b. For example, the latching spring 35 including the arms 35a and 35b and the elastic joint 35c may be formed by an elastic steel wire. However, other materials may be used such as elastic plastic. The first end portion of spring arm 35b is connected or engaged with or latched with the slider. The second end portion of spring arm 35a is engaged with or connected with the trapping recess 36.

Irrespective of the material, it is also possible to have the spring arms 35a and 35b made elastic so no elastic joint is necessary, but the spring arms 35a and 35b may elastically bend so as to provide for the desired spring action.

As illustrated by FIG. 5, the movable latching element 31 may be formed by one end portion of said latching spring 35 and may be supported at the handle 3 or a carrier element attached thereto. The other end portion of the latching spring 35 may be supported at the slider 8 so as to move together with the slider 8 in the sliding direction 22.

The latching element 31 which may be formed by the aforementioned end portion of spring arm 35a, is movably supported at the handle 3 or the aforementioned carrier element attached thereto so as to be movable in the latching direction 33 and also, to some extent, in the sliding direction 22.

More particularly, the latching element 31 may be guided in a trapping recess which may be formed in the handle 3 and which may give the latching element 31 some freedom in the sliding direction 22 as well as in the latching direction 33. However, depending on the position of the latching element 31 in the sliding direction 22, the freedom in transverse direction is different.

The trapping recess 36 may form a restrictor 37 which may restrict the transverse movements of the latching element 31 in the latching direction 33 depending on the sliding direction of the slider 8 and/or the starting point of the slider 8 from which the slider 8 approaches the intermediate position.

As can be seen from FIG. 5, the restrictor 37, more particularly the trapping recess 36 thereof, includes a catching jaw 38 which is open towards the working position of the slider 8 and closed towards the parking position thereof. The catching jaw 38 restricts the transverse movement of the latching element 31 so as to keep it away from the latching contour 32 and/or preventing the latching element 31 from snapping into the latching contour 32 when positioned in said catching jaw 38.

On the other hand, when the latching element 31 is in another section of the trapping recess 36 outside said catching jaw 38, the latching element 31 may move in the latching direction 33 further towards the latching contour 32 and more particularly, it is allowed to snap into said latching contour 32.

Whether or not the latching element 31 moves into the catching jaw 38 or not, depends on the direction of movement of the slider 8 and on the position of the slider 8.

When starting from the parking position shown in FIG. 2a, the latching element 31 is outside the catching jaw 38 and contacts a portion of the cam surface 34 on a first side of the latching contour 32. When starting movement towards the intermediate position of the slider 8, the end of latching spring 35 attached to the slider 8 follows the sliding movement of the slider 8. In addition, the latching element 31 rides on the cam surface 34, as it is restricted in the trapping recess 36 and may not follow the sliding movement of the slider 8. When the slider 8 approaches its intermediate position, the latching element 31 riding on cam surface 34 approaches the latching contour 32 and may snap into the recess of latching contour 32, since the latching element 31 is not positioned in the catching jaw 38, but in the neighboring sector allowing for further transverse movement in the latching direction 33, cf. FIGS. 6b and 6c in combination with FIG. 5.

When moving the slider 8 further towards the active working position, the latching spring 35 is further rotated, as the latching spring 35 is attached at one end portion to the slider 8 and held in the trapping recess 38 at the handle 3. Since the cam surface 34 of the slider 8 is moved together with the slider 8, the latching element 31 further rides on the cam surface 34 to leave the latching contour 32. As the latching contour 32 may form of V-shaped recess, the slider 8 is elastically held in the intermediate position, but may be moved out of the intermediate position when overcoming the elastic holding forces. More particularly, when driving action in the sliding direction 22 is large enough, the sloped portions of the latching contour 32 urge the latching element 31 in the transverse direction opposite to the latching direction 33.

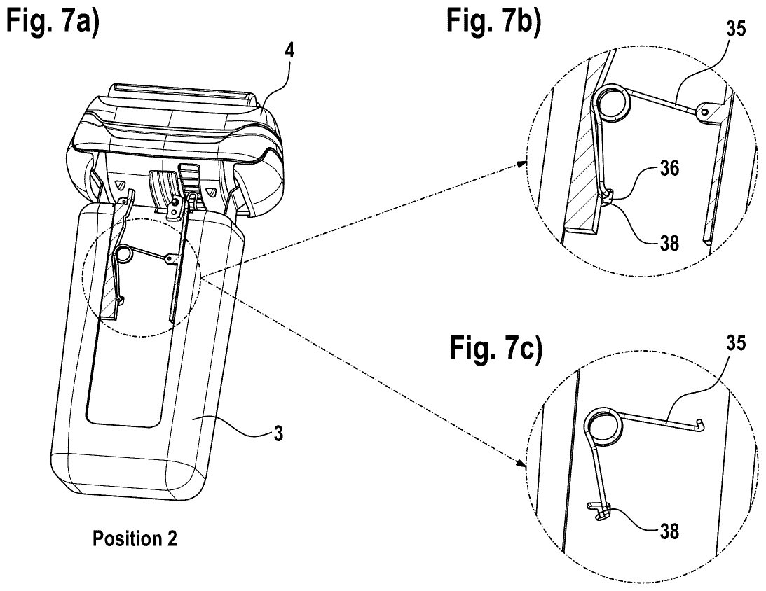

As illustrated by FIG. 2c and FIG. 6, the cam surface 34 urges the latching element 31 in the transverse direction into a position in which the latching element 31 would not engage latching contour 32. More precisely, the latching element 31 is pushed towards the right end side of trapping recess 36 when the slider 8 is in its working position so as to allow the latching element 31 to enter the catching jaw 38 when the slider 8 is moved back again from the working position towards the intermediate position or parking position as illustrated by FIG. 7.

As the latching element 7 is elastically pushed against cam surface 34, it follows the initial sliding movement of slider 8 in the sliding direction 22 as the trapping recess 36 provides for some freedom in the sliding direction for the latching element 31. Thus, the latching element 31 enters into the catching jaw 38, cf. FIG. 7, when the slider 8 starts moving from the working position towards the parking position.

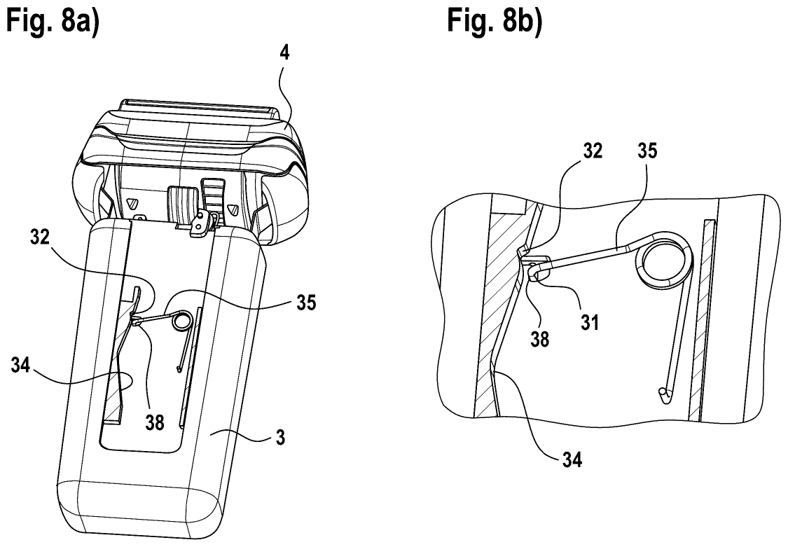

As the latching element 31 is trapped in said catching jaw 38 when moving the slider 8 towards the parking position, the latching element 31 may not snap into the latching contour 32 when passing the intermediate position, as illustrated by FIG. 8, since catching jaw 38 restricts movements of the latching element 31 in the latching direction 33. Thus, the slider moves directly downwards into the parking position 0 without stopping at the intermediate position 1 when moved in that downward direction.

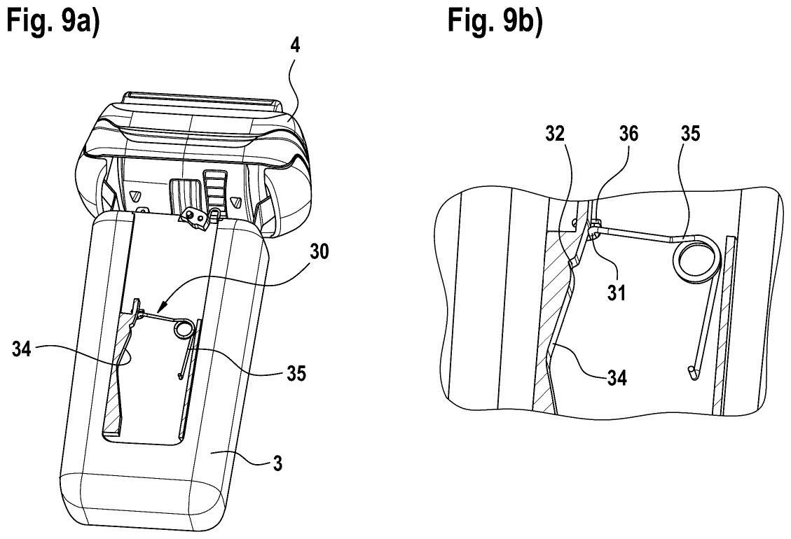

When reaching the parking position again, cf. FIG. 9, cam surface 34 urges the latching element 31 towards the exit portion of catching jaw 38 so, due to the pretension of latching spring 35, the latching element 31 again may move, due to the freedom in sliding direction, out of the catching jaw 38 to be position in the other sector of trapping recess 36 so the latching spring 35 again assumes the configuration shown in FIG. 2a, i.e. the starting position when the slider is in the parking position.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

Every document cited herein, including any cross referenced or related patent or application and any patent application or patent to which this application claims priority or benefit thereof, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. Personal care device such as a hair cutter or electric shaver, comprising a handle, a working head attached to said handle, and a slider which is provided with a supplementary working tool such as a longhair trimmer and slidably attached to said handle to slide between an inactive parking position and an active working position for working with the supplementary working tool, wherein a sliding controller is provided for holding said slider in said inactive parking position and/or in said active working position and/or in at least one intermediate position, wherein said sliding controller is configured to hold the slider in said at least one intermediate position only when approaching said at least one intermediate position from a first side and/or in a first sliding direction and to not hold the slider in said at least one intermediate position when approaching said at least one intermediate position from a second side opposite to said first side and/or in a second sliding direction opposite to said first sliding direction.

2. Personal care device according to claim 1, wherein said sliding controller is configured to hold the slider in said at least one intermediate position only when coming from the inactive parking position and to not hold the slider in said intermediate position when coming from the active working position.

3. Personal care device according to claim 1, wherein said sliding controller includes a movable latching element supported movably into and out of engagement with a latching contour along a latching direction which is transverse to the sliding direction of the slider, wherein a restrictor is provided for restricting movements of the latching element in the latching direction towards the latching contour to prevent the latching element from locking engagement with said latching contour when the slider approaches the intermediate position from said second side and/or in said second sliding direction.

4. Personal care device according to claim 3, wherein said latching element is supported movably in the sliding direction of the slider in a restricted manner, wherein said restrictor includes a catching jaw for catching said latching element when moving in said second sliding direction, said catching jaw being configured to restrict movement of the latching element in said latching direction to prevent the latching element from engaging with the latching contour when said latching element has entered into the catching jaw.

5. Personal care device according to claim 4, wherein said catching jaw is open towards the active working position of the slider and closed towards the inactive parking position of the slider.

6. Personal care device according to claim 4, wherein said restrictor includes a trapping recess in which the latching element is movably guided, said trapping recess including two sectors neighboring each other and/or spaced apart from each other in the sliding direction, wherein said two sectors provide for different transverse freedom in the latching direction for the latching element.

7. Personal care device according to claim 6, wherein a first one of said sectors of the trapping recess is closer to the active working position of the slider and allows for transverse movement of the latching element in the latching direction to engage with the latching contour, and a second one of said sectors of the trapping recess allows for restricted transverse movements of the latching element in the latching direction to prevent the latching element from engaging with the latching contour.

8. Personal care device according to claim 7, wherein said trapping recess is attached to the handle or a carrier attached thereto, and said latching contour is attached to the slider so that the latching contour passes the trapping recess when the slider is sliding relative to the handle.

9. Personal care device according to claim 1, wherein the latching element is biased by a latching spring in the latching direction towards the latching contour.

10. Personal care device according to claim 9, wherein said latching element is a part or an end portion of said latching spring.

11. Personal care device according to claim 10, wherein said latching spring includes two spring arms which are elastically bendable and/or are connected to each other by an elastic joint to allow bending of the spring arms relative to each other.

12. Personal care device according to claim 11, wherein said latching spring is positioned between the slider and the handle and/or is configured for bending in a plane tangential to the handle as well as to the slider.

13. Personal care device according to claim 12, wherein the latching spring, with one end portion, is supported at the handle and, with another end portion, is attached to the slider, wherein the end portion of the latching spring supported at the handle is movable relative to the handle in the sliding direction of the slider and in the latching direction transverse to said sliding direction, wherein stopping contours are provided for limiting both movements in the sliding direction and in the latching direction.

14. Personal care device according to claim 13, wherein said latching spring is attached, with its two end portions, to said handle and said slider at two attachment points or regions spaced from each other in the latching direction transverse to the sliding direction so the latching spring is rotated and/or bent when the slider is sliding relative to the handle.

15. Personal care device according to claim 1, wherein the sliding controller includes a cam surface along which the latching element is riding when the slider is moved in the sliding direction relative to the handle, said cam surface including the latching contour.

16. Personal care device according to claim 15, wherein said cam surface is fixed to the slider such that the cam surface passes the latching element supported at the handle and urges the latching element to move in the latching direction when the slider is sliding relative to the handle.
